(19) United States
(12) Patent Application Publication
(10) Pub. No.: US 2021/0185522 A1
(43) Pub. Date: Jun. 17, 2021

(54) SYSTEM AND METHOD FOR SECURE WIRELESS DISTRIBUTION OF MACHINE READABLE CODE

(71) Applicant: Kith Creative Inc., San Jose, CA (US)

(72) Inventor: Taehyun PARK, San Francisco, CA (US)

(21) Appl. No.: 16/711,016

(22) Filed: Dec. 11, 2019

(51) Int. Cl. H04W 12/00; H04W 12/06; H04W 12/04

(52) U.S. Cl. CPC H04W 12/0017; H04W 12/04031; H04W 12/0608

(57) ABSTRACT

Methods and systems for secure distribution of decryption code are described. A method, performed by a first electronic device includes encrypting a packet that includes code and a one-time password to obtain an encrypted packet; and wirelessly broadcasting the encrypted packet. A method, performed by a second electronic device includes receiving a wirelessly broadcast encrypted packet; in accordance with a determination that predefined decryption criteria are satisfied, decrypting the encrypted packet based at least on a third key to obtain code; decrypting at least a portion of encrypted data using the code; and providing the decrypted portion to one or more programs for further processing.

### TECHNICAL FIELD

This application relates generally to wireless distribution of information, and more particularly to secure distribution of information via wireless broadcasting.

### BACKGROUND

In recent years, the use of optical machine readable codes (e.g., barcodes and matrix codes) has increased significantly. In particular with the increased adoption of portable electronic devices with cameras (e.g., mobile phones), optical machine readable codes are widely used as a way to provide information that does not require a user to type in characters. For example, optical machine readable code may contain a universal resource locator, which allows a user to access a web page corresponding to the universal resource locator by scanning the optical machine readable code instead of typing in the universal resource locator.

However, optical machine readable codes require a user to be within a sight range to scan the optical machine readable codes. Thus, a user cannot use optical machine readable code that is not visible (e.g., covered by another object or located outside the sight range from the user).

### SUMMARY

The devices and methods described herein address challenges associated with conventional machine readable codes. The disclosed devices and methods allow wireless broadcasting of the code information, which eliminates the need for a user to scan codes with optical sensors (e.g., camera).

However, wirelessly broadcasting the code information may lead to non-targeted devices receiving the code information. Thus, the devices and methods described herein include wirelessly broadcasting encrypted code information so that only targeted devices (e.g., devices with decryption keys) may retrieve the code information.

In accordance with some embodiments, a method is performed at a broadcasting device with one or more processors and memory. The method includes encrypting a first packet that includes first code and a first one-time password to obtain a first encrypted packet. The first code corresponds to at least a first portion of data uploaded to a server that is located remotely from the broadcasting device. The method also includes wirelessly broadcasting the first encrypted packet.

In accordance with some embodiments, an electronic device includes wireless communication circuit; one or more processors; and memory storing one or more programs. The one or more programs include instructions, which, when executed by the one or more processors, cause the electronic device to encrypt a first packet that includes first code and a first one-time password to obtain a first encrypted packet. The first code corresponds to at least a first portion of data uploaded to a server that is located remotely from the electronic device. The one or more programs include instructions, which, when executed by the one or more processors, cause the electronic device to wirelessly broadcast the first encrypted packet.

In accordance with some embodiments, a computer readable storage medium includes one or more programs for execution by one or more processors of an electronic device. The one or more programs include instructions for encrypting a first packet that includes first code and a first one-time password to obtain a first encrypted packet. The first code corresponds to at least a first portion of data uploaded to a server that is located remotely from the broadcasting device. The one or more programs also include instructions for wirelessly broadcasting the first encrypted packet.

In accordance with some embodiments, a method is performed at a recipient device with one or more processors and memory storing one or more programs. The method includes receiving a first encrypted packet wirelessly broadcast from a broadcasting device. The first encrypted packet includes encryption of information identifying a first code. The method also includes, in accordance with a determination that predefined decryption criteria are satisfied, decrypting the first encrypted packet based at least on a third key to obtain the first code. The third key is received from a server that is located remotely from the recipient device. The method further includes decrypting at least a first portion of encrypted data stored in the memory using the first code; and providing the decrypted first portion to the one or more programs stored in the memory.

In accordance with some embodiments, an electronic device includes wireless communication circuit; one or more processors; and memory storing one or more programs. The one or more programs include instructions, which, when executed by the one or more processors, cause the electronic device to receive a first encrypted packet wirelessly broadcast from a broadcasting device. The first encrypted packet includes encryption of information identifying a first code. The one or more programs also include instructions, which, when executed by the one or more processors, cause the electronic device to, in accordance with a determination that predefined decryption criteria are satisfied, decrypt the first encrypted packet based at least on a third key to obtain the first code. The third key is received from a server that is located remotely from the electronic device. The one or more programs further include instructions, which, when executed by the one or more processors, cause the electronic device to decrypt at least a first portion of encrypted data stored in the memory using the first code, and provide the decrypted first portion to one or more programs stored in the memory.

In accordance with some embodiments, a computer readable storage medium includes one or more programs for execution by one or more processors of an electronic device. The one or more programs include instructions for receiving a first encrypted packet wirelessly broadcast from a broadcasting device. The first encrypted packet includes encryption of information identifying a first code. The one or more programs also include instructions for, in accordance with a determination that predefined decryption criteria are satisfied, decrypting the first encrypted packet based at least on a third key to obtain the first code. The third key is received from a server that is located remotely from the recipient device. The one or more programs further include instructions for decrypting at least a first portion of encrypted data stored in the memory using the first code; and providing the decrypted first portion to the one or more programs stored in the memory.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a diagram illustrating a distributed computer system according to certain embodiments of the invention.

FIG. 2A is a block diagram illustrating a broadcasting device in accordance with some embodiments.

FIG. 2B is a block diagram illustrating a recipient device in accordance with some embodiments.

FIG. 3 is a block diagram illustrating a server system in accordance with some embodiments.

FIG. 4A is a block diagram that illustrates a data structure of a packet in accordance with some embodiments.

FIG. 4B is a diagram that illustrates timing of wireless broadcasting in accordance with some embodiments.

FIGS. 5A-5B are flow diagrams illustrating interaction among a broadcasting device, a recipient device, and a server system, in accordance with some embodiments.

FIG. 6 is a flow diagram illustrating a method performed by a broadcasting device in accordance with some embodiments.

FIGS. 7A and 7B illustrate a flow diagram illustrating a method performed by a recipient device in accordance with some embodiments.

### DESCRIPTION OF EMBODIMENTS

There have been needs for distributing information to electronic devices. Typing a long information string, such as a universal resource locator, is cumbersome, time-consuming, and error prone. Optical machine readable codes can provide information without requiring a user to type in characters, and have gained popularity. However, optical machine readable codes require a user to be located within a proximity (typically within a sight range) to scan the optical machine readable codes. Thus, a user cannot use optical machine readable code that is not visible (e.g., covered by another object or located outside the sight range from the user).

Wireless distribution of information eliminates the need for optical scanning of machine readable code, and allows distribution of the information over a longer distance than optical scanning of machine readable code. However, at the same time, wireless distribution of information may allow an unintended device (or a party) to receive the information, which can lead to misuse of the information. Thus, there is a need for maintaining the security of the wirelessly distributed information. As described herein, encryption of the information followed by wireless broadcasting of the encrypted information improves the security of the information even when the information is wirelessly broadcast, thereby reducing the access to the information by unintended devices. Furthermore, the encryption and decryption operations described herein allow decryption of the encrypted information even when a recipient device is not in communication with a wireless communication network.

Reference will be made to embodiments, examples of which are illustrated in the accompanying drawings. In the following description, numerous specific details are set forth in order to provide a thorough understanding of the various described embodiments. However, it will be apparent to one of ordinary skill in the art that the various described embodiments may be practiced without these particular details. In other instances, methods, procedures, components, circuits, and networks that are well-known to those of ordinary skill in the art are not described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first actuator could be termed a second actuator, and, similarly, a second actuator could be termed a first actuator, without departing from the scope of the various described embodiments. The first actuator and the second actuator are both actuators, but they are not the same actuator.

The terminology used in the description of the embodiments herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting (the stated condition or event)” or “in response to detecting (the stated condition or event),” depending on the context.

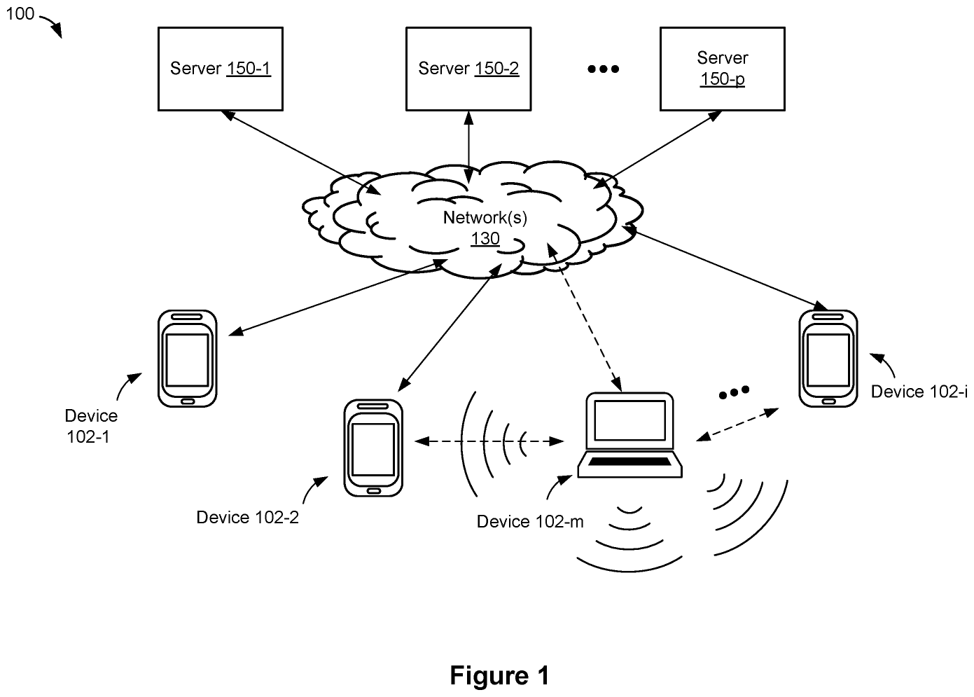

FIG. 1 is a block diagram illustrating a distributed computer system 100 in accordance with some embodiments. In FIG. 1, system 100 may include one or more devices 102 (e.g., devices 120-1 through 120-m and then through 120-i), a communications network 130, and one or more servers 150 (e.g., servers 150-1 through 150-p).

Devices 102 can be any of a number of devices (e.g., Internet kiosk, personal digital assistant, cell phone, gaming device, desktop computer, laptop computer, handheld computer, or combinations thereof) used to enable the activities described below. In some embodiments, one or more devices 102 are portable. In some embodiments, one or more devices 102 are static (e.g., non-portable). At least one of devices 102 (e.g., device 102-m) is a broadcasting device (e.g., a device that wirelessly broadcasts information), and at least one of devices 102 (e.g., device 102-2 and device 102-i) is a recipient device (e.g., a device that wirelessly receives information).

In some embodiments, one or more devices 102 are connected to one or more server 150 via communications network 130. In some embodiments, communications network 130 is the Internet. In other embodiments, communications network 130 can be any local area network (LAN), wide area network (WAN), metropolitan area network, or a combination of such networks. In some embodiments, communications network 130 includes a wired network and/or a wireless network (e.g., Wi-Fi, Bluetooth, ZigBee, etc.). In some embodiments, one or more devices 102 communicate with each other pursuant to a wireless communication protocol (e.g., Wi-Fi, Bluetooth, ZigBee, etc.).

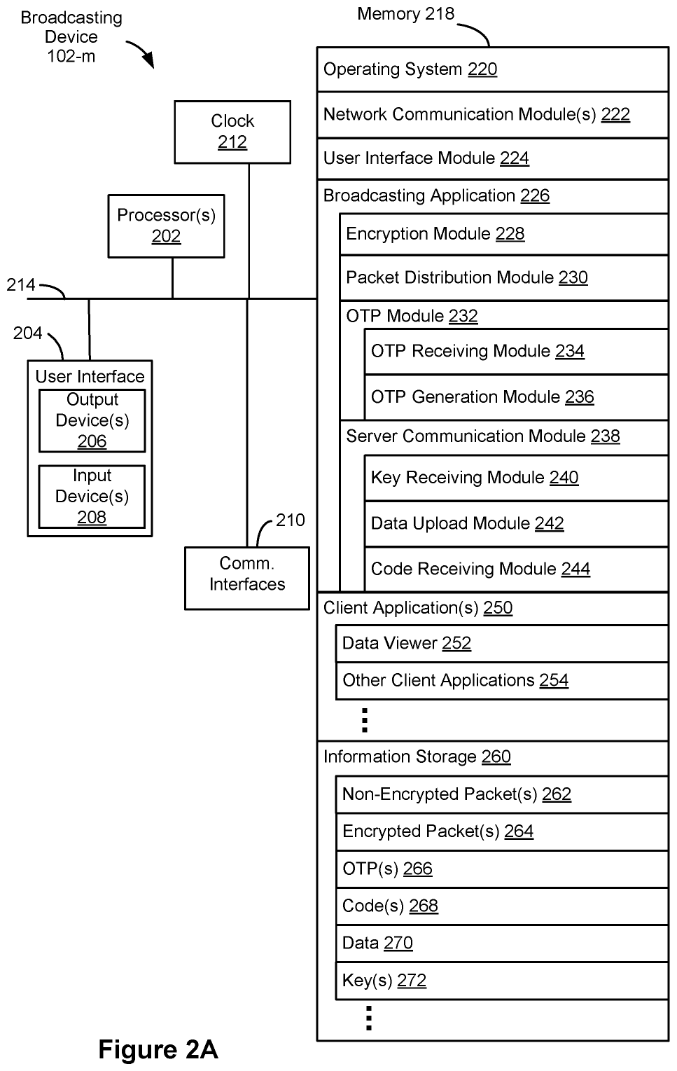

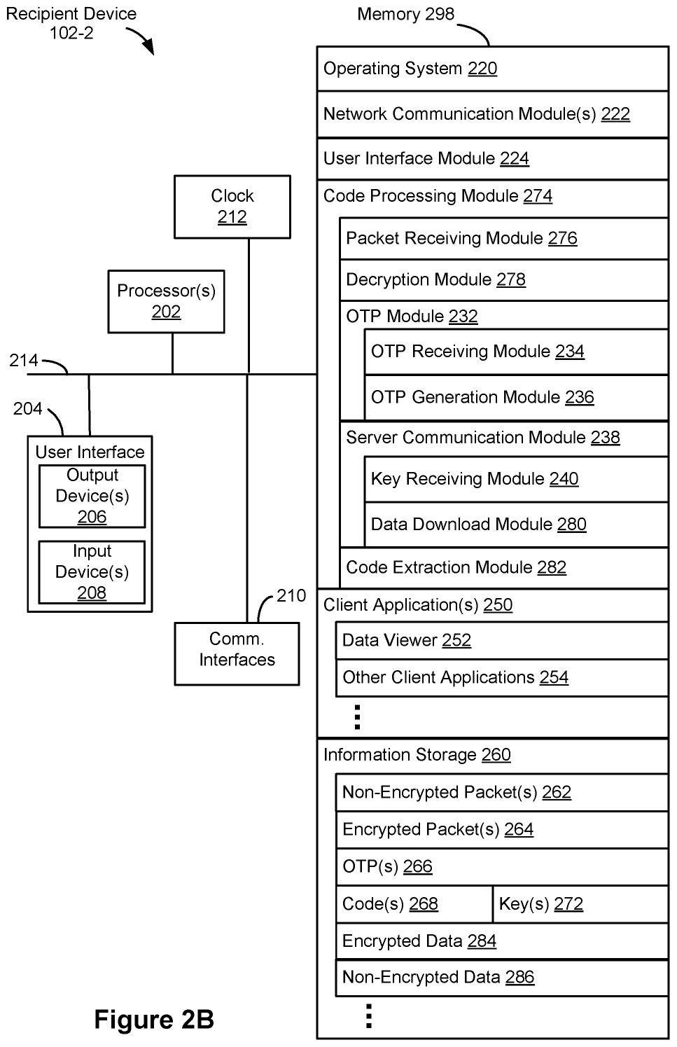

FIG. 2A is a block diagram illustrating broadcasting device 102-m in accordance with some embodiments.

In some embodiments, broadcasting device 102-m is a desktop computer. In some embodiments, broadcasting device 102-m is portable (e.g., a notebook computer, tablet computer, or handheld device, such as a mobile phone).

In some embodiments, broadcasting device 102-m includes user interface 204, which typically includes one or more output devices 206, such as a display device, and one or more input devices 208, such as a keyboard, a mouse, a pointing device (e.g., a stylus), and/or a touch-sensitive surface. In some embodiments, the touch-sensitive surface is integrated with the display device (in which case, the touch-sensitive surface and the display device are collectively called herein a touch-sensitive display). In some other embodiments, the touch-sensitive surface (e.g., a trackpad) is separate from the display device.

Broadcasting device 102-m typically includes one or more processors 202 (e.g., microprocessors, central processing units (CPUs), accelerated processing units (APU), etc.), one or more network or other communications interfaces 210, memory 218, and one or more communication buses 214 for interconnecting these components. In some embodiments, one or more processors 202 and memory 218 are integrated (e.g., application-specific integrated circuit or field-programmable gate array). In some embodiments, the communication buses 214 include circuitry (sometimes called a chipset) that interconnects and controls communications between system components. In some embodiments, broadcasting device 102-m also includes clock 212 that generates electrical signal that identifies current time. In some embodiments, clock 212 includes an electronic oscillator (e.g., an oscillator that is regulated by a quartz crystal) and a counter circuit for counting oscillations generated by the electronic oscillator.

Communication interfaces 210 include one or more circuits for wired and/or wireless communications. In some embodiments, communication interfaces 210 include radio frequency (RF) circuit. The RF circuit receives and sends RF signals, also called electromagnetic signals. The RF circuit converts electrical signals to/from electromagnetic signals and communicates with communications networks and other communications devices via the electromagnetic signals. The RF circuit optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuit optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

Memory 218 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 218 may optionally include one or more storage devices remotely located from processor(s) 302. Memory 218, or alternately the non-volatile memory device(s) within memory 218, comprises a computer readable storage medium. In some embodiments, memory 218, or the non-volatile memory device(s) within memory 218, comprises a non-transitory computer readable storage medium. In some embodiments, memory 218 or the computer readable storage medium of memory 218 stores the following programs, modules and data structures, or a subset thereof:
Operating System 220 that includes procedures for handling various basic system services and for performing hardware dependent tasks;
Network Communication Module (or instructions) 222 that is used for connecting broadcasting device 102-m to other computers (e.g., server 150) via one or more communication interfaces 210, and optionally via one or more communications networks 130 (FIG. 1), such as the Internet, other wide area networks, local area networks, metropolitan area networks, and so on;
User Interface Module 224 that is used for presenting operating user interface 204 (e.g., receiving input signals from input devices 208 and providing output signals, such as graphical user interfaces, to output devices 206);
Broadcasting Application 226 that is used for broadcasting encrypted information;
Client Application(s) 250 that includes one or more software applications that can be executed by processor(s) 202, such as Data Viewer 252 and other client applications 254; and
Information Storage 260 for storing one or more data structures.

In some embodiments, Broadcasting Application 226 includes the following programs, modules and data structures, or a subset or superset thereof:
Encryption Module 228 for encrypting information (e.g., encrypting Non-Encrypted Packet(s) 262 to obtain Encrypted Packet(s) 264 using one or more encryption algorithms, such as the Rivest-Shamir-Adleman algorithm);
Packet Distribution Module 230, which is used, optionally in conjunction with Network Communication Module 222 and/or Network Interfaces 210, for distributing data packets (e.g., Encrypted Packet(s) 264);
OTP Module 232 for receiving or generating one-time passwords (OTPs) 266; and
Server Communication Module 238, which is used, optionally in conjunction with Network Communication Module 222 and/or Network Interfaces 210, for sending data and/or information to, and retrieving data and/or information from, server 150.

In some embodiments, OTP Module 232 includes the following programs, modules and data structures, or a subset or superset thereof:
OTP Receiving Module 234 for receiving one-time password (OTP), for example from one or more servers 150, and/or storing the one-time password in Information Storage 260 as OTP(s) 266; and
OTP Generation Module 236 for generating one-time password (OTP) and/or storing the one-time password in Information Storage 260 as OTP(s) 266.

In some embodiments, Server Communication Module 238 includes the following programs, modules and data structures, or a subset or superset thereof:
Key Receiving Module 240 for receiving one or more keys, for example from one or more servers 150 and/or storing the one or more keys in Information Storage 260 as Key(s) 272;
Data Upload Module 242 for retrieving data (e.g., Data 270) from Information Storage 260 and/or sending the data, for example to one or more servers 150; and
Code Receiving Module 244 for receiving one or more codes, for example from one or more servers 150, and/or storing the one or more codes in Information Storage 260 as Code(s) 268.

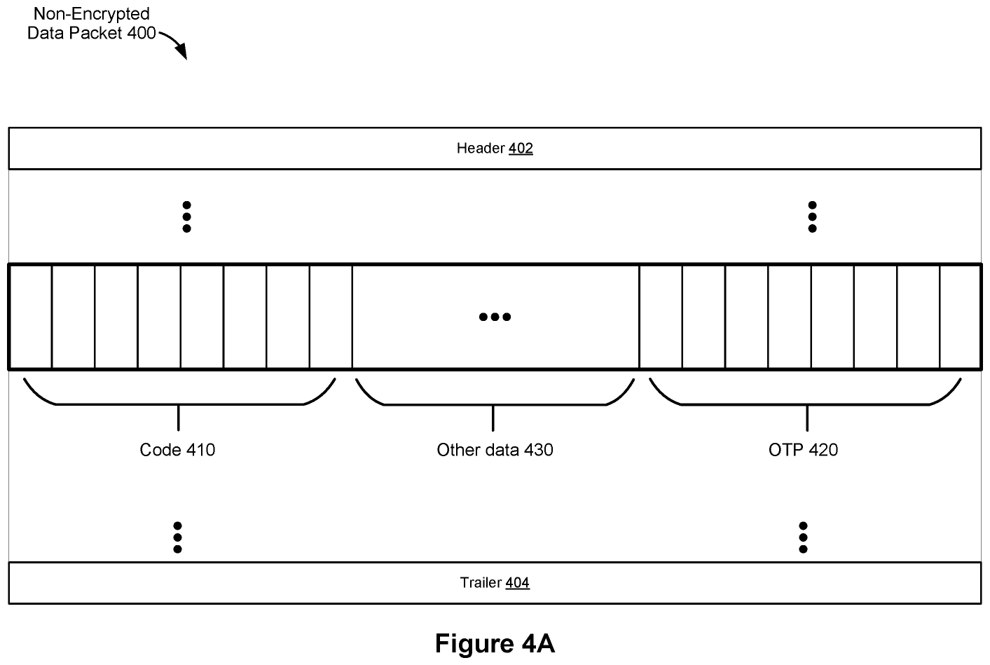

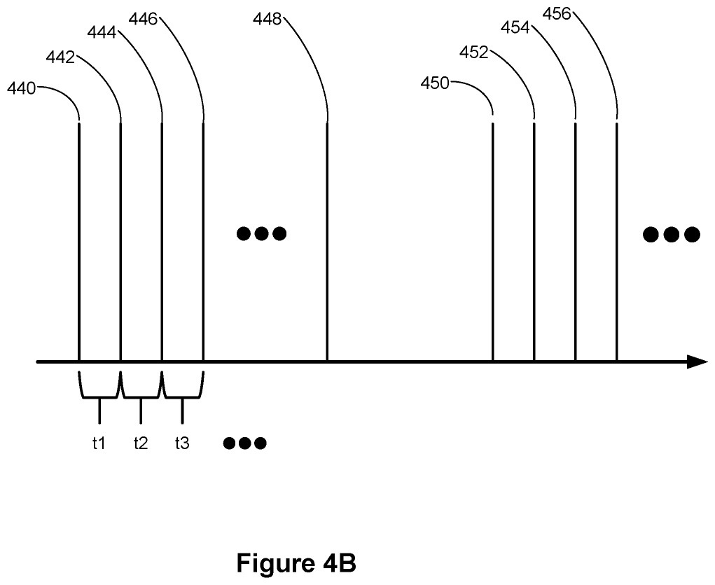

In some embodiments, Information Storage 260 includes the following data, data structures, information, or a subset or superset thereof:
Non-Encrypted Packet(s) 262, which is described further with respect to FIG. 4A;
Encrypted Packet(s) 264, which is obtained by for example encrypting Non-Encrypted Packet(s) 262 (e.g., with Encryption Module 228 using OTP(s) 266 and/or Key(s) 272);
OTP(s) 266, which is obtained for example from OTP Module 232;
Code(s) 268, which is received for example from Code Receiving Module 244;
Data 270 that may or may not be encrypted; and
Key(s) 272, which is received for example from Key Receiving Module 240.

Each of the above identified software systems, procedures, modules, and applications correspond to a set of instructions for performing one or more functions described above. These modules (e.g., sets of instructions) need not be implemented as separate software programs, procedures, or modules, and thus various subsets of these modules may be combined or otherwise re-arranged in various embodiments. In some embodiments, memory 218 may store a subset of the modules and data structures identified above. Furthermore, memory 218 may store additional modules and data structures not described above.

FIG. 2B is a block diagram illustrating recipient device 102-2 in accordance with some embodiments.

In some embodiments, recipient device 102-2 is a desktop computer. In some embodiments, recipient device 102-2 is portable (e.g., a notebook computer, tablet computer, or handheld device, such as a mobile phone).

Recipient device 102-2 includes one or more components analogous to those described above with respect to broadcasting device 102-m (e.g., processor(s) 202, user interface 204, communication interfaces 210, clock 212, etc.). For brevity detailed description of these components are omitted herein.

Memory 298 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 298 may optionally include one or more storage devices remotely located from processor(s) 302. Memory 298, or alternately the non-volatile memory device(s) within memory 298, comprises a computer readable storage medium. In some embodiments, memory 298, or the non-volatile memory device(s) within memory 298, comprises a non-transitory computer readable storage medium. In some embodiments, memory 298 or the computer readable storage medium of memory 298 stores the following programs, modules and data structures, or a subset thereof:
Operating System 220 that includes procedures for handling various basic system services and for performing hardware dependent tasks;
Network Communication Module (or instructions) 222 that is used for connecting recipient device 102-2 to other computers (e.g., server 150) via one or more communication interfaces 210, and optionally via one or more communications networks 130 (FIG. 1), such as the Internet, other wide area networks, local area networks, metropolitan area networks, and so on;
User Interface Module 224 that is used for presenting operating user interface 204 (e.g., receiving input signals from input devices 208 and providing output signals, such as graphical user interfaces, to output devices 206);
Code Processing Module 274 that is used for extracting and/or using code;
Client Application(s) 250 that includes one or more software applications that can be executed by processor(s) 202, such as Data Viewer 252 and other client applications 254; and
Information Storage 260 for storing one or more data structures.

In some embodiments, Code Processing Module 274 includes the following programs, modules and data structures, or a subset or superset thereof:
Packet Receiving Module 276, which is used, optionally in conjunction with Network Communication Module 222 and/or Network Interfaces 210, for receiving data packets and/or storing the received data packets in Information Storage 260 as Encrypted Packet(s) 264;
Decryption Module 278 for decrypting information (e.g., decrypting Encrypted Packet(s) 264 to obtain Non-Encrypted Packet(s) 262 and/or decrypting at least a portion of Data 270 to obtain Non-Encrypted Data 286, using one or more decryption algorithms, such as the Rivest-Shamir-Adleman algorithm);
OTP Module 232 for receiving or generating one-time passwords (OTPs) 266;
Server Communication Module 238, which is used, optionally in conjunction with Network Communication Module 222 and/or Network Interface 210, for sending data and/or information to, and retrieving data and/or information from, server 150; and
Code Extraction Module 282, which is used, optionally in conjunction with Decryption Module 278, for extracting code from Non-Encrypted Packet(s) 262 and/or storing the extracted code in Information Storage 260 as Code(s) 268.

In some embodiments, OTP Module 232 includes the following programs, modules and data structures, or a subset or superset thereof:
OTP Receiving Module 234 for receiving one-time password (OTP), for example from one or more servers 150, and/or storing the one-time password in Information Storage 260 as OTP(s) 266; and
OTP Generation Module 236 for generating one-time password (OTP) and/or storing the one-time password in Information Storage 260 as OTP(s) 266.

In some embodiments, Server Communication Module 238 includes the following programs, modules and data structures, or a subset or superset thereof:
Key Receiving Module 240, which is used, optionally in conjunction with Network Communication Module 222 and/or Network Interface 210, for receiving one or more keys, for example from one or more servers 150 and/or storing the one or more keys in Information Storage 260 as Key(s) 272; and
Data Download Module 280, which is used, optionally in conjunction with Network Communication Module 222 and/or Network Interface 210, for receiving data from one or more servers 150 and/or storing the received data in Information Storage 260 as Data 270.

In some embodiments, Information Storage 260 includes the following data, data structures, information, or a subset or superset thereof:
Non-Encrypted Packet(s) 262, which is obtained for example by decrypting Encrypted Packet(s) 264 with Decryption Module 278 using OTP(s) 266 and/or Key(s) 272;
Encrypted Packet(s) 264, which is obtained for example from Packet Receiving Module 276;
OTP(s) 266, which is obtained for example from OTP Module 232;
Code(s) 268, which is received for example from Code Extraction Module 282;
Key(s) 272, which is received for example from Key Receiving Module 240;
Encrypted Data 284, which is received for example from Data Download Module 280; and
Non-Encrypted Data 286, which is received for example from Decryption Module 278 by decrypting at least a portion of Encrypted Data 284 using Code(s) 268.

Each of the above identified software systems, procedures, modules, and applications correspond to a set of instructions for performing one or more functions described above. These modules (e.g., sets of instructions) need not be implemented as separate software programs, procedures, or modules, and thus various subsets of these modules may be combined or otherwise re-arranged in various embodiments. In some embodiments, memory 298 may store a subset of the modules and data structures identified above. Furthermore, memory 298 may store additional modules and data structures not described above.

Although broadcasting device 102-m and recipient device 102-2 are illustrated as separate devices in FIGS. 1 and 2A-2B based on their functions, in some embodiments, a same device may operate as a broadcasting device at a first time and as a recipient device at a second time that is distinct from (e.g., subsequent to) the first time. In such embodiments, broadcasting device 102-m may include one or more components of recipient device 102-2, and recipient device 102-2 may include one or more components of broadcasting device 102-m. In some embodiments, a single device includes all of the components illustrated in FIGS. 2A and 2B.

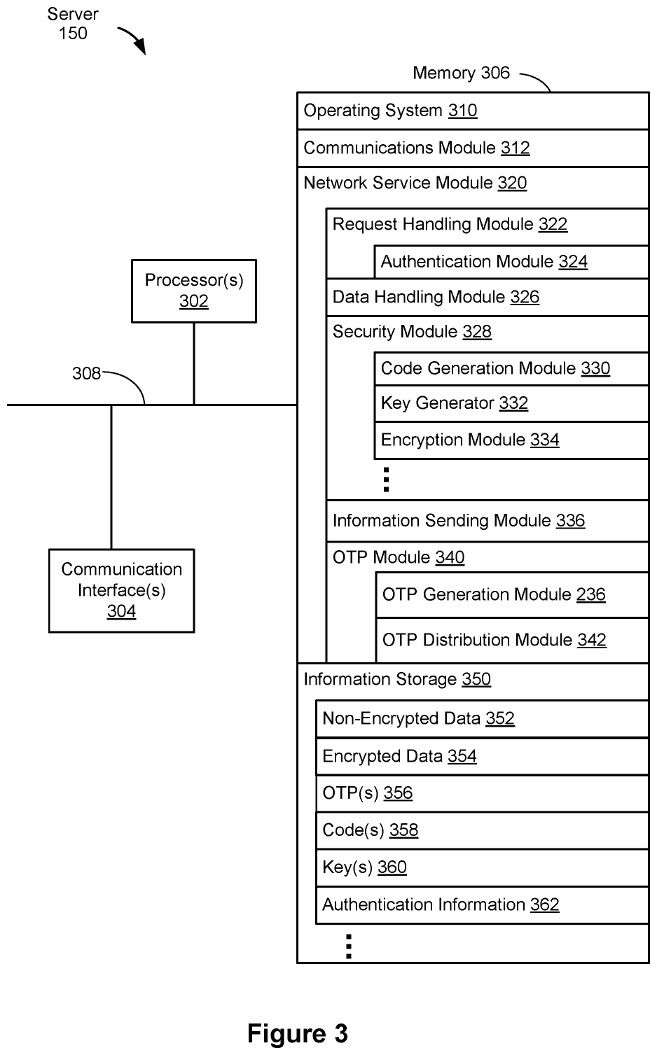

FIG. 3 is a block diagram illustrating server system 150 in accordance with some embodiments.

Server system 150 typically includes one or more processors 302 (e.g., microprocessors, central processing units (CPUs), accelerated processing units (APU), etc.), one or more network or other communications interfaces 304, memory 306, and one or more communication buses 308 for interconnecting these components. In some embodiments, one or more processors 302 and memory 306 are integrated (e.g., application-specific integrated circuit or field-programmable gate array). In some embodiments, the communication buses 308 include circuitry (sometimes called a chipset) that interconnects and controls communications between system components. In some other embodiments, server system 150 includes a user interface (e.g., a user interface having a display device, a keyboard, and a mouse or other pointing device), but more typically server system 150 is controlled from and accessed by various client systems.

Communication interfaces 304 include one or more circuits for wired and/or wireless communications. In some embodiments, communication interfaces 304 include radio frequency (RF) circuit. The RF circuit receives and sends RF signals, also called electromagnetic signals. The RF circuit converts electrical signals to/from electromagnetic signals and communicates with communications networks and other communications devices via the electromagnetic signals. The RF circuit optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuit optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSDPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

Memory 306 of server system 150 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from processor(s) 302. Memory 306, or alternately the non-volatile memory device(s) within memory 306, comprises a computer readable storage medium. In some embodiments, memory 306, or the non-volatile memory device(s) within memory 306, comprises a non-transitory computer readable storage medium. In some embodiments, memory 306 or the computer readable storage medium of memory 306 stores the following programs, modules and data structures, or a subset thereof:
Operating System 310 that includes procedures for handling various basic system services and for performing hardware dependent tasks;
Communication Module (or instructions) 312 that is used for connecting server system 150 to other computers (e.g., client devices 102) via one or more network interfaces 304 and one or more communications networks 130 (FIG. 1), such as the Internet, other wide area networks, local area networks, metropolitan area networks, and so on;
Network Service Module 320 that receives requests and/or data from client devices 102 and sends encrypted data, codes, and keys to client devices 102; and
Information Storage 350 that is used for storing one or more data structures.

In some embodiments, Network Service Module 320 includes the following programs, modules and data structures, or a subset or superset thereof:
Request Handling Module 316, which is used, optionally in conjunction with Communications Module 312 and/or Communication Interface(s) 304, for receiving and processing requests from client devices 102, such as a request to upload data, a request to download encrypted data, a request for a one-time password, a request for one or more keys, etc.;
Data Handling Module 326, which is used, optionally in conjunction with Communications Module 312 and/or Communication Interface(s) 304, for receiving upload data and/or sending encrypted data;
Security Module 328, which is used for encryption of data and/or maintaining information (e.g., codes and keys) associated with encryption of data;
Information Sending Module 336, which is used, optionally in conjunction with Communications Module 312 and/or Communication Interface(s) 304, for sending one-time passwords, codes, and keys to respective devices 102; and
OTP Module for generating and sending one-time passwords (OTPs) 356.

In some embodiments, Request Handling Module 322 includes Authentication Module 324 for authenticating devices or users sending the request, for example based on Authentication Information 362 (e.g., user and password information, a unique identifier for a device, such as a media access control address, an Internet Protocol address, etc.) in Information Storage 350.

In some embodiments, Security Module 328 includes the following programs, modules and data structures, or a subset or superset thereof:
Code Generation Module 330 for generating one or more codes, which are used for encrypting Non-Encrypted Data 352, and/or storing the one or more codes in Information Storage 350 as Code(s) 358;
Key Generator 332 for generating one or more keys and/or storing the one or more keys in Information Storage 350 as Key(s) 360, which are used for generating one-time passwords and/or encrypting data packets at client devices 102; and
Encryption Module 334 for encrypting Non-Encrypted Data 352 using a corresponding code in Code(s) 358 to obtain Encrypted Data 354 (e.g., using one or more decryption algorithms, such as the Rivest-Shamir-Adleman algorithm).

In some embodiments, OTP Module 340 includes the following programs, modules and data structures, or a subset or superset thereof:
OTP Generation Module 236 for generating one-time password (OTP) and/or storing the one-time password in Information Storage 350 as OTP(s) 356; and
OTP Distribution Module 342 for retrieving OTP(s) 266 from Information Storage 350 and/or sending one-time password (OTP), for example to one or more client devices 102.

In some embodiments, Information Storage 350 includes the following data structures, or a subset or superset thereof:
Non-Encrypted Data 352, which is obtained for example from Data Handling Module 326;
Encrypted Data 354, which is obtained for example from Encryption Module 334 by encrypting Non-Encrypted Data 352;
OTP(s) 356, which is obtained for example from OTP Module 340;
Code(s) 358, which is obtained for example from Code Generation Module 330;
Key(s) 360, which is obtained for example from Key Generator 332; and
Authentication Information 362.

Each of the above identified software systems, procedures, modules, and applications correspond to a set of instructions for performing one or more functions described above. These modules (i.e., sets of instructions) need not be implemented as separate software programs, procedures, or modules, and thus various subsets of these modules may be combined or otherwise re-arranged in various embodiments. In some embodiments, memory 306 may store a subset of the modules and data structures identified above. Furthermore, memory 306 may store additional modules and data structures not described above.

The actual number of servers used to implement distributed computing system 100 and how features are allocated among them will vary from one implementation to another, and may depend in part on the amount of data traffic that the system must handle during peak usage periods as well as during average usage periods, and may also depend on the amount of data stored by the distributed computing system. Moreover, one or more of the blocks in FIG. 3 may be implemented on one or more servers designed to provide the described functionality (e.g., Request Handling Module 322 and Security Module 328 may be implemented on two separate servers).

FIG. 4A is a block diagram that illustrates a data structure of a non-encrypted data packet 400 in accordance with some embodiments.

The data packet 400 includes code 410 and one-time password (OTP) 420. In some embodiments, the data packet 400 also includes one or more of: header 402, trailer 404, and other data 430.

FIG. 4B is a diagram that illustrates timing of wireless broadcasting in accordance with some embodiments.

In FIG. 4B, broadcasting device 102-m wirelessly broadcasts a first set of encrypted packets. For example, broadcasting device 102-m wirelessly broadcasts first encrypted packet 440 at a first time, second encrypted packet 442 different from first encrypted packet 440 at a second time, third encrypted packet 444 at a third time, fourth encrypted packet 446 at a fourth time, and n-th encrypted packet 448 at an n-th time. In some embodiments, first encrypted packet 440, second encrypted packet 442, third encrypted packet 444, fourth encrypted packet 446, and n-th encrypted packet 448 are different from one another. For example, although each of first encrypted packet 440, second encrypted packet 442, third encrypted packet 444, fourth encrypted packet 446, and n-th encrypted packet 448 may include the first code, first encrypted packet 440 may include a first one-time password (e.g., without a second one-time password, a third one-time password, a fourth one-time password, and an n-th one-time password), second encrypted packet 442 may include the second one-time password (e.g., without the first one-time password, the third one-time password, the fourth one-time password, and the n-th one-time password), third encrypted packet 444 may include a third one-time password (e.g., without the first one-time password, the second one-time password, the fourth one-time password, and the n-th one-time password), fourth encrypted packet 446 may include a fourth one-time password (e.g., without the first one-time password, the second one-time password, the third one-time password, and the n-th one-time password), and n-th encrypted packet 448 may include an n-th one-time password (e.g., without the first one-time password, the second one-time password, the third one-time password, and the fourth one-time password). In some embodiments, each of first encrypted packet 440, second encrypted packet 442, third encrypted packet 444, fourth encrypted packet 446, and n-th encrypted packet 448 may include a unique code (e.g., first encrypted packet 440 includes the first code, second encrypted packet 442 includes a second code distinct from the first code, third encrypted packet 444 includes a third code distinct from the first code and the second code, fourth encrypted packet 446 includes a fourth code distinct from the first code, the second code, and the third code, and n-th encrypted packet 446 includes an n-th code distinct from the first code, the second code, the third code, and the fourth code. Other variations are possible. For example, a first group of two or more encrypted packets may include the first code without the second code and a second group of two or more encrypted packets may include the second code without the first code (e.g., first encrypted packet 440 and second encrypted packet 442 may include the first code, and third encrypted packet 444 and fourth encrypted packet 446 may include the second code; alternatively, first encrypted packet 440 and third encrypted packet 444 may include the first code, and second encrypted packet 442 and fourth encrypted packet 446 may include the second code). For brevity, such variations are omitted herein.

FIG. 4B also shows that broadcasting device 102-m wirelessly broadcasts a second set of encrypted packets (e.g., packets 450, 452, 454, and 456). In some embodiments, each of the second set of encrypted packets includes a second code that is distinct from the first code. In some embodiments, each of the second set of encrypted packets includes a unique one-time password (e.g., the one-time password in packet 450 is different from any one-time password in packets 452, 454, and 456).

FIG. 4B further shows that second encrypted packet 442 is wirelessly broadcast after time interval t1 from wireless broadcasting of first encrypted packet 440, third encrypted packet 444 is wirelessly broadcast after time interval t2 from wireless broadcasting of second encrypted packet 442, third encrypted packet 444 is wirelessly broadcast after time interval t3 from wireless broadcasting of second encrypted packet 442, and so on. In some embodiments, the time interval is synchronous. For example, the time intervals t1, t2, and t3 are identical (e.g., t1, t2, and t3 may be 100 ms). In some other embodiments, the time interval is asynchronous. For example, at least one of the time intervals t1, t2, and t3 is different from the rest of the time intervals (e.g., t1 and t3 are 100 ms and t2 is 200 ms). In another example, all of the time intervals t1, t2, and t3 are different from one another.

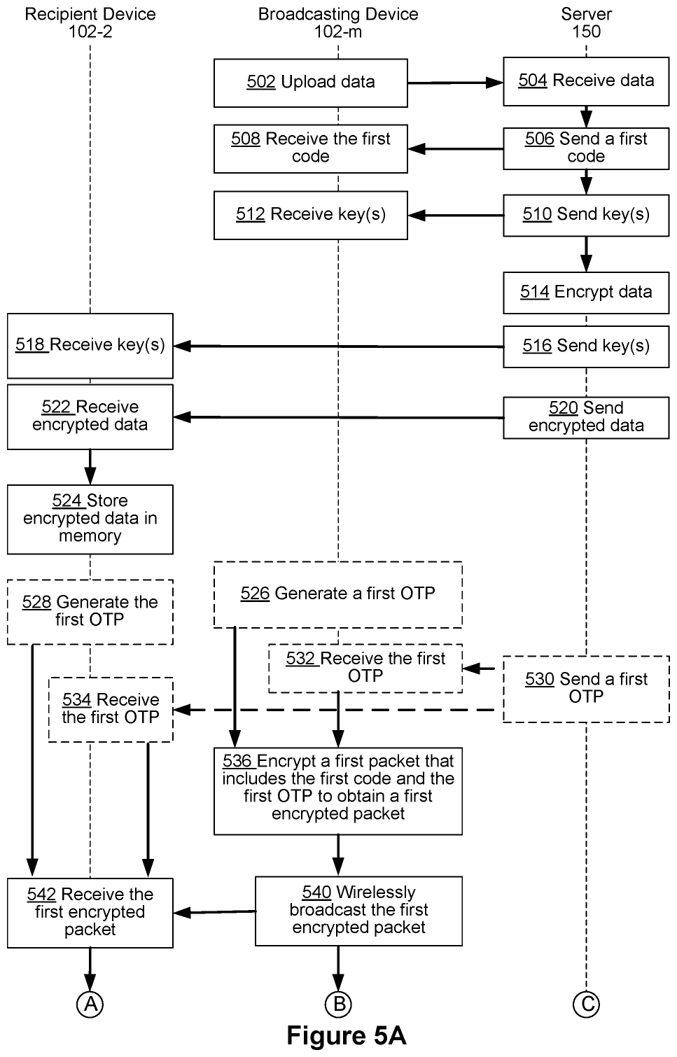

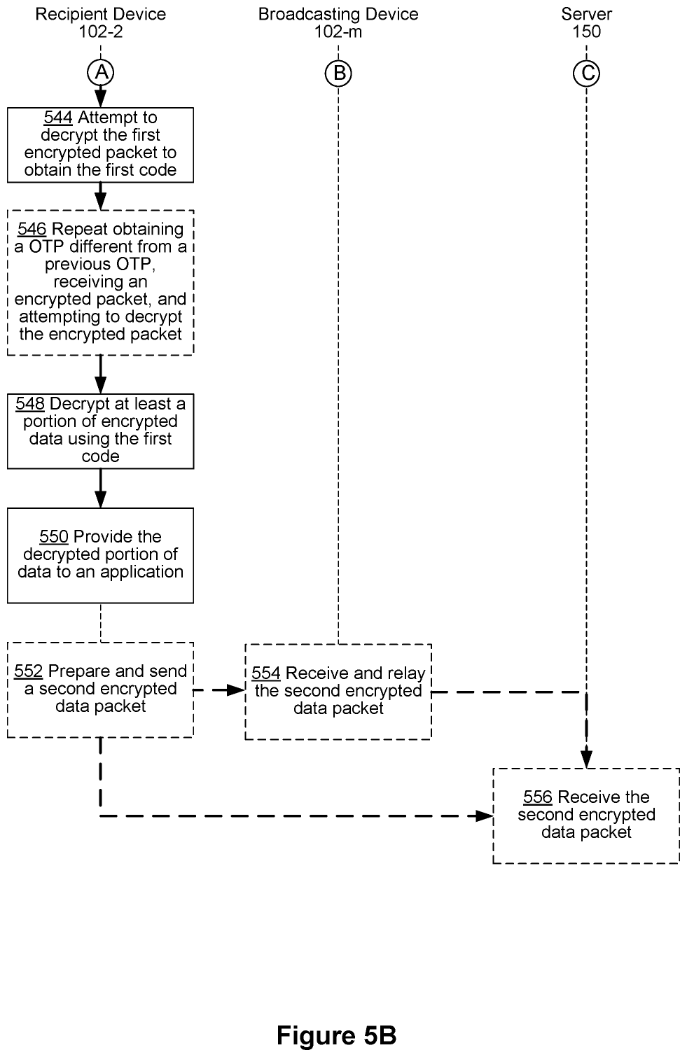

FIGS. 5A-5B are flow diagrams illustrating interaction among a broadcasting device, a recipient device, and a server system, in accordance with some embodiments.

In FIG. 5A, broadcasting device 102-m (502) uploads (e.g., sends) data to server 150, for subsequent distribution of the data to other devices (e.g., recipient device 102-2) through server 150. Server 150 (504) receives the data.

In association with (or in response to) receiving the data, server 150 (506) sends a first code (e.g., a unique code that corresponds to the data) to broadcasting device 102-m, and broadcasting device 102-m (508) receives the first code.

Subsequent to receiving the data (e.g., in association with receiving the data or later), server 150 (510) sends one or more keys to broadcasting device 102-m and broadcasting device 102-m receives the one or more keys.

Also subsequent to receiving the data (e.g., in response to receiving the data), server 150 (514) encrypts and stores the data.

Server 150 also (516) sends one or more keys to recipient device 102-2 and recipient device 102-2 (518) receives the one or more keys.

Server 150 further (520) sends the encrypted data to recipient device 102-2 and recipient device 102-2 (522) receives and (524) stores the encrypted data. However, until recipient device 102-2 decrypts the encrypted data or at least a portion thereof, recipient device 102-2 cannot access non-encrypted information in the encrypted data. Thus, even if the encrypted data is received by an unintended device, access to the non-encrypted information in the encrypted data is restricted, thereby increasing security of the distributed data.

Broadcasting device 102-m obtains a first one-time password (OTP). In some embodiments, broadcasting device 102-m (526) generates the first one-time password (OTP), for example based on a local clock and/or at least one of the one or more keys that broadcasting device 102-m received from server 150. In some embodiments, recipient device 102-2 (528) also generates the first one-time password (OTP), for example based on a local clock and/or at least one of the one or more keys that recipient device 102-2 received from server 150. In some other embodiments, server 150 (530) distributes (e.g., sends) the first one-time password (OTP) (e.g., to broadcasting device 102-m and recipient device 102-2), and broadcasting device 102-m (532) receives the first one-time password (OTP) and recipient device 102-2 (534) receives the first one-time password (OTP).

Broadcasting device 102-m (536) encrypts a first packet (e.g., non-encrypted data packet 400) that includes both the first code and the first one-time password (OTP), thereby obtaining a first encrypted packet.

Broadcasting device 102-m (540) wirelessly broadcasts the first encrypted packet, and recipient device 102-2 (542) receives (and stores) the first encrypted packet. Even if the first encrypted data packet is received by an unintended device, access to the first code in the first encrypted data packet is restricted (because the first encrypted data packet is encrypted with the first OTP and a key), thereby improving security of the first code. In some embodiments, broadcasting device 102-m broadcasts the first encrypted packet using a Bluetooth Low Energy (BLE) protocol.

Recipient device 102-2 (544) attempts to decrypt the first encrypted packet to obtain the first code.

In some embodiments, the recipient device 102-2 (546) repeats (1) obtaining a one-time password (OTP) that is different from a previous one-time password (or at least a predefined number, such as 100, of previous one-time passwords), (2) receiving an encrypted packet, and (3) attempting to decrypt the encrypted packet.

If recipient device 102-2 succeeds to decrypt the first encrypted packet, recipient device 102-2 (548) decrypts at least a portion of the encrypted data using the first code.

Recipient device 102-2 subsequently (550) provides the decrypted portion of the data to an application (e.g., for display of the decrypted portion of the data, or using the decrypted portion of the data to access another data stored in recipient device 102-2 or remotely from recipient device 102-2 (e.g., data stored at server 150 or another remote server system). Thus, the decrypted portion of the data is accessible when recipient device 102-2 successfully decrypts the portion of the encrypted data using the first code, which is, in turn, obtained by decrypting an encrypted data packet. This multi-level encryption method facilitates improving security in data transfer.

In some embodiments, recipient device 102-2 encrypts a second data packet (e.g., a data packet including information indicating that the first encrypted packet has been decrypted or that the encrypted portion of the data has been decrypted, for example, by recipient device 102-2) with one of the one or more keys received from server 150 (e.g., a public key provided by server 150), thereby obtaining a second encrypted data packet. In some embodiments, recipient device 102-2 (552) sends the second encrypted data packet to broadcasting device 102-m (e.g., by wireless communication, such as Bluetooth, Bluetooth Low Energy, etc.). In some embodiments, broadcasting device 102-m (554) relays (e.g., sends) the second encrypted data packet to server 150. In some embodiments, recipient device 102-2 (552) sends the second encrypted data packet directly to server 150 (without going through broadcasting device 102-m). When broadcasting device 102-m does not have a key to decrypt the second encrypted data packet (e.g., broadcasting device 102-m does not have a private key that corresponds to the public key provided by server 150), broadcasting device 102-m cannot decrypt the second encrypted data packet (and hence, cannot manipulate the information indicating that the first encrypted packet has been decrypted or that the encrypted portion of the data has been decrypted).

In some embodiments, server 150 (556) receives the second encrypted data packet. In some embodiments, server 150 (556) decrypts the second encrypted data packet to retrieve the information indicating that the first encrypted packet has been decrypted or that the encrypted portion of the data has been decrypted.

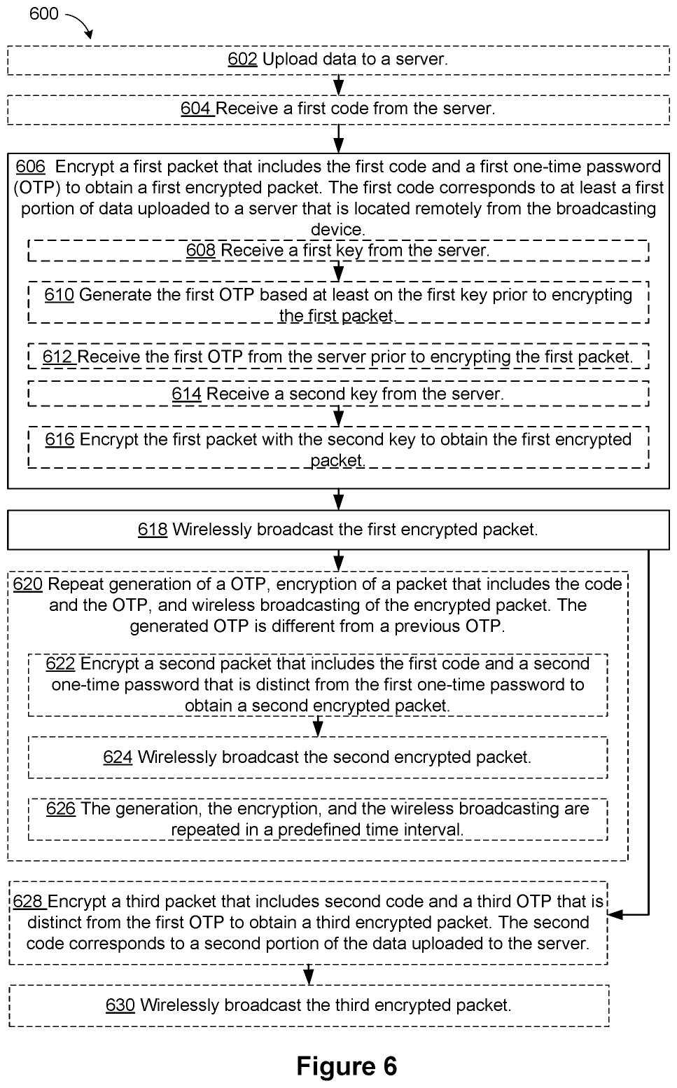

FIG. 6 is a flow diagram illustrating method 600 performed by a broadcasting device (e.g., broadcasting device 102-m shown in FIG. 2A) in accordance with some embodiments.

In some embodiments, method 600 includes (602) uploading data to the server prior to wirelessly broadcasting the first encrypted packet (e.g., operation 502, optionally using Data Upload Module 242). For example, broadcasting device 102-m may send the data to the server over the Internet (e.g., using Transmission Control Protocol/Internet Protocol).

In some embodiments, method 600 includes (604) receiving first code from the server (e.g., operation 508, optionally using Code Receiving Module 244). In some embodiments, the first code is sent from the server to the broadcasting device in response to the broadcasting device uploading the data to the server. Thus, in such embodiments, broadcasting device 102-m may receive the first code in association with (or in conjunction with) uploading the data to the server.

Method 600 includes (606) encrypting a first packet (e.g., a non-encrypted data packet 400) that includes the first code and a first one-time password to obtain a first encrypted packet (e.g., operation 536, optionally using Encryption Module 228). The first code corresponds to at least a first portion of the data uploaded to a server that is located remotely from the broadcasting device. For example, as shown in FIG. 5A, server 150 may send the first code to broadcasting device 102-m in response to receiving the data from broadcasting device 102-m. Various algorithms may be used to encrypt the first packet. For example, the Rivest-Shamir-Adleman (RSA) algorithm or any of its variants may be used to encrypt the first packet. In some cases, other encryption algorithms (e.g., Data Encryption Standard or Triple DES algorithm) may be used to encrypt the first packet. In some embodiments, the encryption algorithm may be symmetric or asymmetric.

In some embodiments, method 600 includes (608) receiving a first key from the server (e.g., operation 512, optionally using Key Receiving Module 240). In some embodiments, the first key is used for generating one or more one-time passwords. Method 600 also includes (610) generating the first one-time password based at least on the first key prior to encrypting the first packet (e.g., operation 526, optionally using OTP Generation Module 236). In some embodiments, the first one-time password is a time-synchronized one-time password (e.g., typically also based on clock 212 of the broadcasting device generates the one-time password based in part on time information from clock 212 of the broadcasting device).

In some embodiments, method 600 includes (612) receiving the first one-time password from the server prior to encrypting the first packet (e.g., operation 532, optionally using OTP Receiving Module 234). This eliminates the need for broadcasting device 102-m to generate the first one-time password (OTP).

In some embodiments, method 600 includes (614) receiving a second key from the server (e.g., operation 512, optionally using Key Receiving Module 240). In some embodiments, the second key is a public key. In some embodiments, the second key is a private key. Method 600 also includes (616) encrypting the first packet with the second key to obtain the first encrypted packet (e.g., operation 536, optionally using Encryption Module 228). This improves security in data transmission so that even when the first code is wirelessly broadcast (which may allow any device within proximity to broadcasting device 102-m to receive the first encrypted packet), only devices that can decrypt the first encrypted packet may retrieve the first code.

Method 600 also includes (618) wirelessly broadcasting the first encrypted packet (e.g., operation 540, optionally using Packet Distribution Module 230). For example, the first encrypted packet is wirelessly broadcast using the Bluetooth Low Energy protocol. In some embodiments, the first encrypted packet is included in an advertising packet. In some embodiments, the first encrypted packet is wirelessly broadcast prior to, or without, forming a wireless connection between the broadcasting device and a recipient device (e.g., pairing of the recipient device and the broadcasting device).

In some embodiments, method 600 includes (620) repeating generation of a one-time password, encryption of a packet that includes the code and the one-time password, and wireless broadcasting of the encrypted packet. The generated one-time password is different from a previous one-time password.

In some embodiments, method 600 includes (622) encrypting a second packet that includes the first code and a second one-time password that is distinct from the first one-time password to obtain a second encrypted packet (e.g., optionally using Encryption Module 228); and, subsequent to wirelessly broadcasting the first encrypted packet, (624) wirelessly broadcasting the second encrypted packet (e.g., optionally using Packet Distribution Module 230).

In some embodiments, method 600 includes generating the second one-time password based at least on the first key prior to encrypting the second packet. In some embodiments, broadcasting device 102-m generates the first one-time password using first time information from the clock of broadcasting device 102-m at a first time and generates the second one-time password using second time information from the clock of broadcasting device 102-m, different from the first time information, at a second time that is different from the first time. In some other embodiments, method 600 includes receiving the second one-time password from the server prior to encrypting the second packet. In some embodiments, method 600 includes encrypting the second packet with the second key to obtain the second encrypted packet.

In some embodiments, the generation, the encryption, and the wireless broadcasting are repeated (626) in a predefined time interval (e.g., 300 ms or less). For example, as shown in FIG. 4B, a plurality of encrypted packets may be wirelessly broadcast over time at the predefined time interval.

In some embodiments, after a certain time interval (e.g., a predefined time interval of less than 50 ms, between 50 mm and 100 ms, between 100 ms and 150 ms, between 150 ms and 200 ms, between 200 ms and 250 ms, between 250 ms and 300 ms, or between 300 ms and 400 ms, such as 50 ms, 100 ms, 150 ms, 200 ms, 250 ms, 300 ms, 350 ms, or 400 ms) from wirelessly broadcasting the first encrypted packet that includes a first one-time password and the first code, broadcasting device 102-m wirelessly broadcasts the second encrypted packet that includes the second one-time password that is different from the first one-time password and the first code. Thus, broadcasting device 102-m distributes (e.g., wirelessly broadcasts) a plurality of encrypted packets that include the first code, while each encrypted packet contains a unique one-time password, as each one-time password is determined based in part on time when the one-time password is created. This requires the recipient device to have the corresponding one-time password when decrypting any encrypted packet, thereby improving the security in distributing the first code.

In some embodiments, method 600 includes (628) encrypting a third packet that includes second code and a third one-time password that is distinct from the first one-time password to obtain a third encrypted packet (e.g., optionally using Encryption Module 228). The second code corresponds to a second portion of the data uploaded to the server (e.g., the server sends to the broadcasting device the second code corresponding to the second portion, distinct from, or mutually exclusive to, the first portion, of the data, and the broadcasting device receives from the server the second code). Method 600 also includes, subsequent to wirelessly broadcasting the first encrypted packet, (630) wirelessly broadcasting the third encrypted packet.

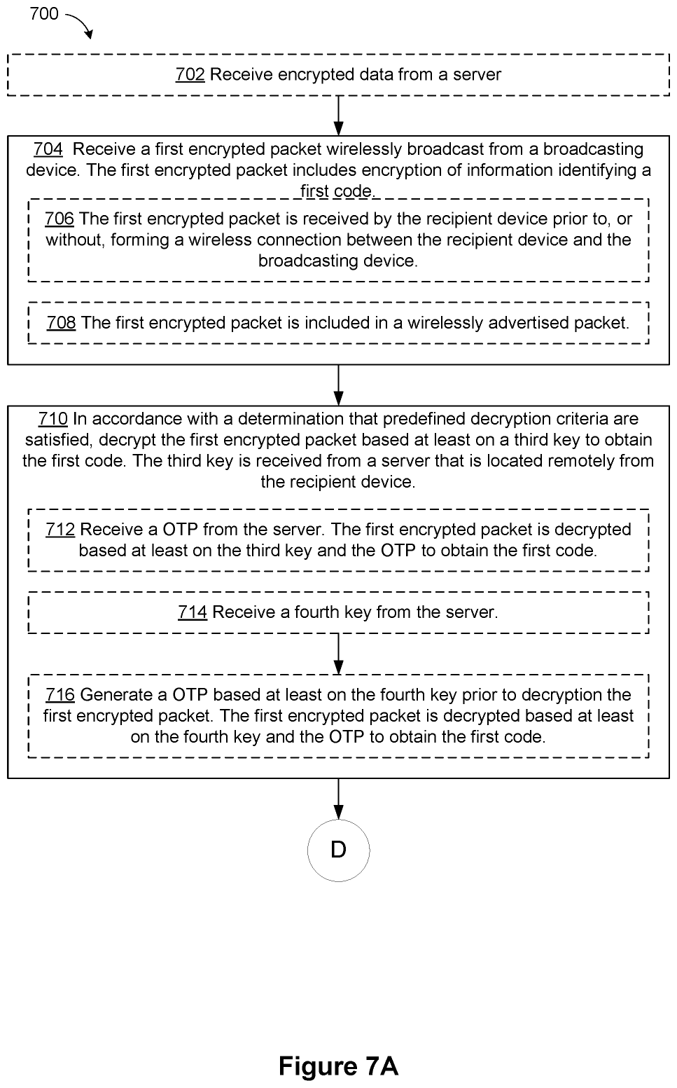

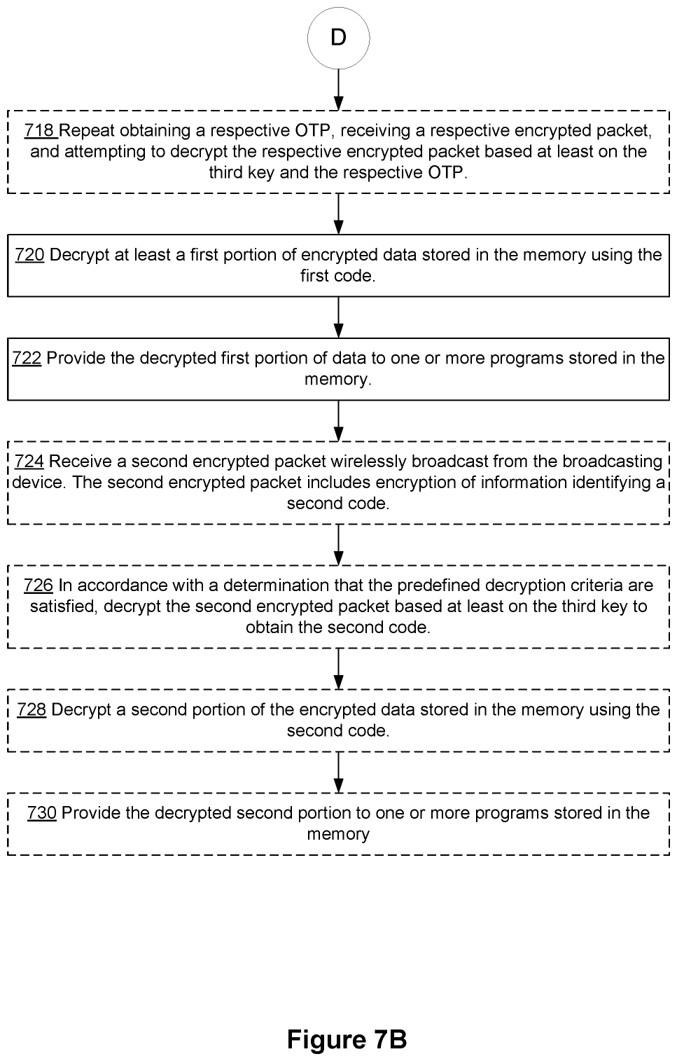

FIGS. 7A and 7B illustrate a flow diagram illustrating method 700 performed by a recipient device (e.g., recipient device 102-2) in accordance with some embodiments.

In some embodiments, method 700 includes (702) receiving the encrypted data from the server (e.g., prior to receiving the first encrypted packet from the broadcasting device) (e.g., operation 522, optionally using Data Download Module 280).

Method 700 includes (704) receiving a first encrypted packet wirelessly broadcast from a broadcasting device (e.g., operation 542, optionally using Packet Receiving Module 276). The first encrypted packet includes encryption of information identifying a first code.

In some embodiments, the first encrypted packet is received (706) by the recipient device prior to, or without, forming a wireless connection between the recipient device and the broadcasting device (e.g., pairing of the recipient device and the broadcasting device). For example, the first encrypted packet is received as an advertising packet broadcast by the broadcasting device (e.g., using the Bluetooth Low Energy protocol). In some embodiments, the first encrypted packet is included (708) in a wirelessly advertised packet (e.g., in a signal of a Bluetooth Low Energy beacon).

Method 700 also includes, in accordance with a determination that predefined decryption criteria are satisfied, (710) decrypting the first encrypted packet based at least on a third key to obtain the first code (e.g., operation 544, optionally using Decryption Module 278 and/or Code Extraction Module 282). In some embodiments, the third key is received from a server that is located remotely from the recipient device (e.g., operation 518, optionally using Key Receiving Module 240). In some embodiments, the third key is a private key that corresponds to the second key when the second key is a public key.

In some embodiments, method 700 includes (712) receiving a one-time password from the server (e.g., operation 534, optionally using OTP Receiving Module 234). The first encrypted packet is decrypted based at least on the third key and the one-time password to obtain the first code (e.g., using the Rivest-Shamir-Adleman algorithm).

In some embodiments, method 700 includes (714) receiving a fourth key from the server (e.g., operation 518, optionally using Key Receiving Module 240). In some embodiments, the fourth key is used for generating one or more one-time passwords. In some embodiments, the fourth key is identical to the first key. Method 700 includes (716) generating a one-time password based at least on the fourth key prior to decrypting the first encrypted packet (e.g., operation 528, optionally using OTP Generation Module 236). The first encrypted packet is decrypted based at least on the third key and the one-time password to obtain the first code.

In some embodiments, method 700 includes (718) repeating obtaining a respective one-time password, receiving a respective encrypted packet, and attempting to decrypt the respective encrypted packet based at least on the third key and the respective one-time password (e.g., operation 546, optionally using Decryption Module 278). The obtained respective one-time password is different from a previously obtained one-time password. In some embodiments, the obtaining and the decrypting are repeated in a predefined time interval (e.g., every 50 ms, 100 ms, 150 ms, 200 ms, 250 ms, 300 ms, 350 ms, 400 ms, 450 ms, or 500 ms, until any encrypted packet is decrypted). In some embodiments, method 700 includes determining that the respective encrypted packet is decrypted based at least on the third key and the respective one-time password.

Method 700 further includes (720) decrypting at least a first portion of encrypted data stored in the memory using the first code (e.g., operation 548, optionally using Decryption Module 278), and (722) providing the decrypted first portion to the one or more programs stored in the memory (e.g., operation 550). In some embodiments, recipient device 102-2 provides the decrypted first portion to Data Viewer 252, which renders the decrypted first portion for display on Output Device 206 (e.g., a display device). For example, the encrypted data includes one or more images or video, and recipient device 102-2 provides a decrypted portion of the one or more images or video to Data Viewer 252 for presentation. In some embodiments, recipient device 102-2 provides the decrypted first portion to other client applications 254. For example, the decrypted first portion is provided a web browser so that recipient device 102-2 may attempts to access data over a network based on information in the decrypted first portion (e.g., a uniform resource locator or a password to retrieve information from server 150 or any other server system) using the web browser. In some embodiments, encrypted data includes one or more audio files and recipient device 102-2 provides one or more decrypted audio files to a music player.

In some embodiments, method 700 includes (724) receiving a second encrypted packet wirelessly broadcast from the broadcasting device (e.g., using Packet Receiving module 276). The second encrypted packet includes encryption of information identifying a second code. In some embodiments, the first code corresponds to a first portion of the data and the second code corresponds to a second portion distinct from, or mutually exclusive to, the first portion of the data. Method 700 also includes, in accordance with a determination that the predefined decryption criteria are satisfied, (726) decrypting the second encrypted packet based at least on the third key to obtain the second code (e.g., using Decryption module 278 and/or Code Extraction Module 282); and (728) decrypting a second portion of the encrypted data stored in the memory using the second code (e.g., using Decryption module 278). Method 700 further includes (730) providing the decrypted second portion to one or more programs stored in the memory.

In some embodiments, the method includes encrypting a response packet with a fifth key (e.g., a public key); and providing the encrypted response packet to the server or the broadcasting device. For example, recipient device 102-2 may send a response packet back to server 150. The response packet may be encrypted to improve security.

In some embodiments, the recipient device sends the encrypted response packet directly to the server (e.g., operation 552 to operation 556). In some other embodiments, the recipient device sends the encrypted response packet directly to the broadcasting device (e.g., operation 552 to operation 554). The broadcasting device receives the encrypted response packet and provide the encrypted response packet to the server (e.g., operation 554). This allows the recipient device to send the response packet (encrypted as the encrypted response packet) to the server even when the recipient device is not in direct communication with the server (e.g., the recipient device does not have access to the Internet, etc.).

The foregoing description, for purpose of explanation, has been described with reference to specific embodiments. However, the illustrative discussions above are not intended to be exhaustive or to limit the scope of claims to the precise forms disclosed. Many modifications and variations are possible in view of the above teachings.

For example, in accordance with some embodiments, a method performed at a recipient device with one or more processors and memory includes receiving a first encrypted packet wirelessly broadcast from a broadcasting device. The first encrypted packet includes encryption of information identifying a first code. The method also includes decrypting the first encrypted packet based at least on a third key to obtain the first code; decrypting at least a first portion of encrypted data stored in the memory using the first code; and providing the decrypted first portion to one or more programs stored in the memory.

The embodiments were chosen and described in order to best explain the principles of the various described embodiments and their practical applications, to thereby enable others skilled in the art to best utilize the invention and the various described embodiments with various modifications as are suited to the particular use contemplated.

What is claimed is:

1. A method, comprising:
at a broadcasting device with one or more processors and memory:
encrypting a first packet that includes first code and a first one-time password to obtain a first encrypted packet, wherein the first code corresponds to at least a first portion of data uploaded to a server that is located remotely from the broadcasting device; and
wirelessly broadcasting the first encrypted packet.

2. The method of claim 1, further comprising:
encrypting a second packet that includes the first code and a second one-time password that is distinct from the first one-time password to obtain a second encrypted packet; and
subsequent to wirelessly broadcasting the first encrypted packet, wirelessly broadcasting the second encrypted packet.

3. The method of claim 1, further comprising:
at the broadcasting device:
receiving a first key from the server; and
generating the first one-time password based at least on the first key prior to encrypting the first packet.

4. The method of claim 1, further comprising:
at the broadcasting device:
receiving the first one-time password from the server prior to encrypting the first packet.

5. The method of claim 1, including:
at the broadcasting device:
receiving a second key from the server; and
encrypting the first packet with the second key to obtain the first encrypted packet.

6. The method of claim 1, further comprising:
at the broadcasting device:
uploading the data to the server prior to wirelessly broadcasting the first encrypted packet.

7. The method of claim 1, further comprising:
at the broadcasting device:
receiving the first code from the server.

8. The method of claim 1, further comprising:
at the broadcasting device:
repeating generation of a one-time password, encryption of a packet that includes a code and the one-time password, and wireless broadcasting of the encrypted packet, wherein the generated one-time password is different from a previous one-time password.

9. The method of claim 8, wherein:
the generation, the encryption, and the wireless broadcasting are repeated in a predefined time interval.

10. The method of claim 1, further comprising:
encrypting a third packet that includes second code and a third one-time password that is distinct from the first one-time password to obtain a third encrypted packet, wherein the second code corresponds to a second portion of the data uploaded to the server; and
subsequent to wirelessly broadcasting the first encrypted packet, wirelessly broadcasting the third encrypted packet.

11. An electronic device, comprising:
wireless communication circuit;
one or more processors; and
memory storing one or more programs, the one or more programs including instructions, which, when executed by the one or more processors, cause the electronic device to perform the method of claim 1.

12. A method, comprising:
at a recipient device with one or more processors and memory storing one or more programs:
receiving a first encrypted packet wirelessly broadcast from a broadcasting device, the first encrypted packet including encryption of information identifying a first code;
in accordance with a determination that predefined decryption criteria are satisfied, decrypting the first encrypted packet based at least on a third key to obtain the first code, wherein the third key is received from a server that is located remotely from the recipient device;
decrypting at least a first portion of encrypted data stored in the memory using the first code; and
providing the decrypted first portion to the one or more programs stored in the memory.

13. The method of claim 12, wherein the first encrypted packet is received by the recipient device prior to, or without, forming a wireless connection between the recipient device and the broadcasting device.

14. The method of claim 12, wherein the first encrypted packet is included in a wirelessly advertised packet.

15. The method of claim 12, further comprising:
at the recipient device:
receiving a fourth key from the server; and
generating a one-time password based at least on the fourth key prior to decrypting the first encrypted packet,
wherein the first encrypted packet is decrypted based at least on the third key and the one-time password to obtain the first code.

16. The method of claim 12, further comprising:
at the recipient device:
receiving a one-time password from the server,
wherein the first encrypted packet is decrypted based at least on the third key and the one-time password to obtain the first code.

17. The method of claim 12, further comprising:
at the recipient device:
receiving the encrypted data from the server.

18. The method of claim 12, further comprising:
at the recipient device:
repeating obtaining a respective one-time password, receiving a respective encrypted packet, and attempting to decrypt the respective encrypted packet based at least on the third key and the respective one-time password, wherein the obtained respective one-time password is different from a previously obtained one-time password.

19. The method of claim 12, further comprising:
at the recipient device:
receiving a second encrypted packet wirelessly broadcast from the broadcasting device, the second encrypted packet including encryption of information identifying a second code;
in accordance with a determination that the predefined decryption criteria are satisfied, decrypting the second encrypted packet based at least on the third key to obtain the second code;
decrypting a second portion of the encrypted data stored in the memory using the second code; and
providing the decrypted second portion to one or more programs stored in the memory.

20. An electronic device, comprising:
wireless communication circuit;
one or more processors; and
memory storing one or more programs, the one or more programs including instructions, which, when executed by the one or more processors, cause the electronic device to perform the method of claim 12.
